(19) United States
(12) Patent Application Publication
(10) Pub. No.: US 2025/0281825 A1
(43) Pub. Date: Sep. 11, 2025

(54) SYSTEM AND METHOD FOR PLAYING WITH PHYSICAL PLAYING CARDS IN A VIRTUAL REALITY SYSTEM

(71) Applicant: PokerClub Inc., Millville, NJ (US)

(72) Inventor: Philip Anthony Huffstickler, Old Hickory, TN (US)

(73) Assignee: PokerClub Inc., Millville, NJ (US)

(21) Appl. No.: 18/759,158

(22) Filed: Jun. 28, 2024

Related U.S. Application Data
(60) Provisional application No. 63/527,385, filed on Jul. 18, 2023.
(60) Provisional application No. 63/558,461, filed on Feb. 27, 2024.

(51) Int. Cl. A63F 13/213; A63F 13/35

(52) U.S. Cl. CPC A63F 13/213; A63F 13/35; A63F 2300/8082

(57) ABSTRACT

A system and method for playing with physical playing cards in virtual or augmented reality. The system includes physical playing cards having corresponding card identities, a card identity recognition system, a web server electronically connected with the card identity recognition system, and a virtual reality viewing device connected with the web server. The card identity recognition system is configured to recognize and convert a card identity into a digital representation of the physical playing card. The web server is configured to host the digital representation of the physical playing card. The virtual reality viewing device is configured to communicate with the web server, receive the digital representation of the physical playing card broadcasted by the web server, decrypt the digital representation of the physical playing card into a virtual visual representation of the card identity, and display the virtual visual representation of the card identity to a human card player.

### CROSS-REFERENCE TO RELATED APPLICATIONS

This non-provisional patent application claims priority to U.S. provisional patent application No. 63/527,385, filed on Jul. 18, 2023, titled “System and method for playing with physical playing cards in a virtual reality system”, and to U.S. provisional patent application No. 63/558,461, filed on Feb. 27, 2024, titled “System and method for playing with physical playing cards in a virtual reality system”, the contents of which are incorporated herein by reference in their entirety and should be considered part of this specification.

### BACKGROUND

Playing with physical cards (also referred to as, for example, “paper cards”) has traditionally been a popular group or community entertainment. This mode of playing cards, however, comes with some challenges. When engaging in the traditional way of playing cards with physical cards, players are limited to those co-players who are physically located in their vicinity. This restriction of physical co-location may restrict opportunities for exploring new gaming communities, playing with individuals from different backgrounds, different geographical locations, and different time zones. Further, the traditionally popular and local nature of physical card games can inadvertently limit the diversity and breadth of experiences that may associate with a wider version of the card playing game such as virtual card games. Further, there remains the inherent physical contact-related constraints of playing with physical cards. Physical cards are subject to wear and tear over time, leading to damaged edges, fading designs, or even misplaced cards. This can hinder the smooth flow of the game and affect the overall player experience. Moreover, in the post-pandemic world after Covid-19, the inevitable human-to-human physical contacts that come with actual playing cards are disadvantageous and physiologically risky to many players, specifically the senior people and those with high morbidity. These and other drawbacks exist.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is an illustrative view of example playing cards, in accordance with an example embodiment of this disclosure.

FIG. 2 is an illustrative view of a card identity recognition system, in accordance with an example embodiment of this disclosure.

FIG. 3 is an illustrative view of a card identity recognition system, in accordance with an example embodiment of this disclosure.

FIG. 4 an illustrative view of a web server, in accordance with an example embodiment of this disclosure.

FIG. 5 an illustrative view of a digital identity interpreter for playing cards, in accordance with an example embodiment of this disclosure.

FIG. 6 is an illustrative view of a virtual visual representation of the card identities of the physical playing cards as viewed on a virtual reality or augmented reality viewing device, in accordance with an example embodiment of this disclosure.

FIG. 7 is an illustrative method of playing a virtual game with playing cards, in accordance with an example embodiment of this disclosure.

FIG. 8 is an illustrative method of playing a virtual game with playing cards, in accordance with an example embodiment of this disclosure.

FIG. 9 is an illustrative virtual reality image of a human card player playing with virtual visual representations of the card identities of the physical playing cards, as viewed on a virtual reality or augmented reality viewing device, in accordance with an example embodiment of this disclosure.

FIG. 10 is an illustrative virtual reality image of a human card player playing with virtual visual representations of the card identities of the physical playing cards, as viewed on a virtual reality or augmented reality viewing device, in accordance with an example embodiment of this disclosure.

FIG. 11 is an illustrative virtual reality image of a human card player playing with virtual visual representations of the card identities of the physical playing cards, as viewed on a virtual reality or augmented reality viewing device, in accordance with an example embodiment of this disclosure.

FIG. 12 is an illustrative virtual reality image of a human card player playing with virtual visual representations of the card identities of the physical playing cards, as viewed on a virtual reality or augmented reality viewing device, in accordance with an example embodiment of this disclosure.

FIG. 13 is an illustrative virtual reality image of a human card player playing with virtual visual representations of the card identities of the physical playing cards, as viewed on a virtual reality or augmented reality viewing device, in accordance with an example embodiment of this disclosure.

FIG. 14 is an illustrative virtual reality image of a human card player playing with virtual visual representations of the card identities of the physical playing cards, as viewed on a virtual reality or augmented reality viewing device, in accordance with an example embodiment of this disclosure.

FIG. 15 is an illustrative virtual reality image of a human card player playing with virtual visual representations of the card identities of the physical playing cards, as viewed on a virtual reality or augmented reality viewing device, in accordance with an example embodiment of this disclosure.

FIG. 16 is a non-limiting, representative and illustrative image of “visionOS” virtual reality operating system of Apple Inc., that may be operationalized in various implementations of the disclosed subject matter.

### DETAILED DESCRIPTION

Various aspects or features of this disclosure are described with reference to the drawings, wherein like reference numerals are used to refer to like elements throughout. In this disclosure, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Various implementations of the disclosed subject matter relate generally to and may provide improvements to apparatus, systems, and methods allowing a human card player to play with physical cards in virtual reality. More particularly, a system and method for playing with physical playing cards in virtual reality may include physical playing cards having corresponding virtual card identities. An example system may include a card identity recognition system configured to recognize a card identity of a physical playing card. A card identity recognition system may be configured to convert the card identity of the physical playing card into a digital or virtual representation of the physical playing card. A card identity recognition system may further include a web server electronically connected with the card identity recognition system. An example web server may be configured to host the digital representation of the physical playing card uploaded by the card identity recognition system.

An example system may also include a virtual reality viewing device electronically connected with a web server and configured to communicate with the web server. A virtual reality viewing device may be further configured to receive the digital representation of the physical playing cards broadcasted by the web server. The virtual reality viewing device may also be configured to decrypt the digital representation of the physical playing card into a virtual visual representation of the card identity of the physical playing card. The virtual reality viewing device may be further configured to display the virtual visual representation of the card identity of the physical playing card to a human card player accessing the virtual reality viewing device and playing with the virtual visual representation of the card identity of the physical playing card.

The present disclosure provides a way to overcome the inherent limitations of traditional ways of playing with physical cards. In the traditional way of playing cards with physical cards, players are limited only to other co-players who are physically located in their vicinity. This restrictions of physical presence may often hinder exploring new gaming communities, playing with individuals from different backgrounds, different geographical locations and different time zones. Further, the examples in the present disclosure offer a wider diversity and breadth of experiences of playing card games. Further, the non-contact aspect of virtual card games may eliminate the typical problems that arise out of wear and tear of the physical cards over time, leading to damaged edges, fading designs, or even misplaced cards. As a result, virtual reality cards games may offer a smooth flow of the game and improve the overall player experience. Moreover, in the post-pandemic world after Covid-19, the added advantage of the non-contact aspect of playing cards in a virtual reality offers a physiologically safe and less risky way of entertainment to many players, specifically the senior people and those with high morbidity.

In an aspect of the disclosed subject matter, a method for playing with physical playing cards in virtual reality is disclosed. The method may include receiving a number of physical playing cards having corresponding card identities, presenting a card identity of a physical playing card to a card identity recognition system, and recognizing the card identity of the physical playing card, by the card identity recognition system.

The card identity recognition system may include a proximity based card identity recognition system. The proximity based card identity recognition system may include a RFID based card identity recognition system. In an instance, the card identity recognition system may be configured to convert the card identity of the physical playing card into the digital representation of the physical playing card.

The card identity recognition system may include an image recognition system configured to recognize an image-bearing face of a physical playing card. The image recognition system may be further configured to convert the image-bearing face of the physical playing card into a digital or virtual representation of the physical playing card. The virtual visual representation of the card identity of the physical playing card may include a virtual visual representation of the image-bearing face of the physical playing card.

The method may also include converting the card identity of the physical playing card into a digital representation of the physical playing card by the card identity recognition system, uploading the digital representation of the physical playing card on a web server by the card identity recognition system, and broadcasting the digital representation of the physical playing card to a virtual reality viewing device by the web server.

The method may further include decrypting the digital representation of the physical playing card into a virtual visual representation of the card identity of the physical playing card by the virtual reality viewing device, displaying the virtual visual representation of the card identity of the physical playing card to a human card player accessing the virtual reality viewing device, and playing with the virtual visual representation of the card identity of the physical playing card in virtual reality by the human card player.

In an aspect of the disclosed subject matter, a system is disclosed for playing with physical playing cards in virtual reality. The system may include a number of physical playing cards having corresponding card identities and a card identity recognition system configured to recognize a card identity of a physical playing card. The card identity recognition system may be further configured to convert the card identity of the physical playing card into a digital representation of the physical playing card.

The system may also include a web server electronically connected with the card identity recognition system. The web server may be configured to host the digital representation of the physical playing card uploaded by the card identity recognition system. The system may also include a virtual reality viewing device electronically connected with the web server and configured to communicate with the web server. The virtual reality viewing device may be further configured to receive the digital representation of the physical playing card broadcasted by the web server. The virtual reality viewing device may be further configured to decrypt the digital representation of the physical playing card into a virtual visual representation of the card identity of the physical playing card. The virtual reality viewing device may be further configured to display the virtual visual representation of the card identity of the physical playing card to a human card player accessing the virtual reality viewing device and playing with the virtual visual representation of the card identity of the physical playing card.

The card identity recognition system may include a proximity based card identity recognition system. The proximity based card identity recognition system may include a RFID based card identity recognition system. The card identity recognition system may be further configured to convert the card identity of the physical playing card into the digital representation of the physical playing card. The card identity recognition system may include an image recognition system configured to recognize an image-bearing face of a physical playing card. The image recognition system may be further configured to convert the image-bearing face of the physical playing card into the digital representation of the physical playing card. The virtual visual representation of the card identity of the physical playing card comprises a virtual visual representation of the image-bearing face of the physical playing card.

In an aspect of the disclosed subject matter, a non-transitory machine-readable storage medium is disclosed that provides instructions that, if executed by a processor, are configurable to cause said processor to perform operations and methods for playing with physical playing cards in virtual reality as disclosed herein.

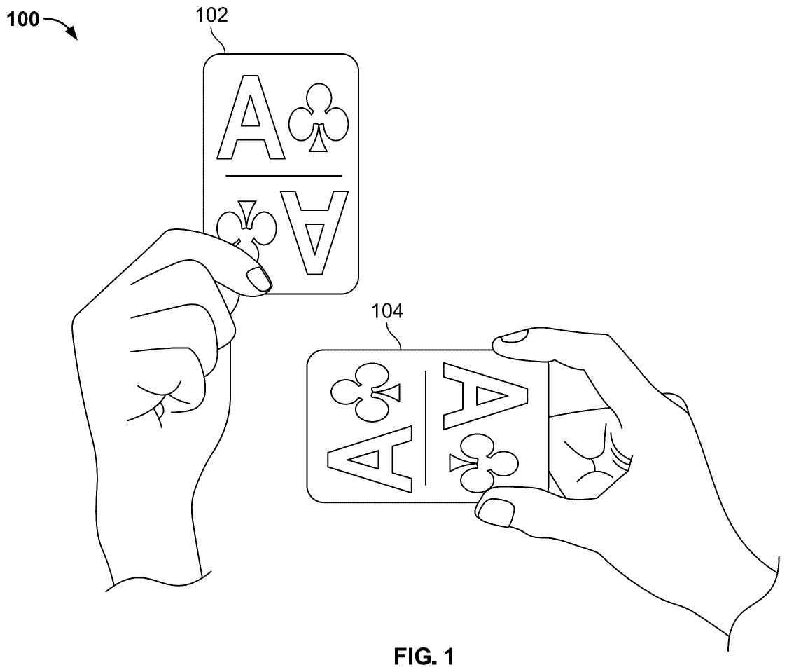

FIG. 1 is an illustrative view 100 of example playing cards, in accordance with an example embodiment of this disclosure. Referring to FIG. 1, a first example playing card 102 and a second example playing card 104 are seen having their front faces displaying corresponding “card identities”, such as “5” of “Spades”, “4” of “Diamonds”, “King” of “Clubs”, “Ace” of “Hearts” and the like. The card identity may typically be unique combinations of the suit of the card such as Spades or Hearts or Diamonds or Clubs and the denomination of the card such as “Ace” or “King” or “Queen” or “10” and the like, or any such unique identification that may singularly identify the card. The playing cards 102 or 104 of FIG. I may be typically coupled with or embedded with RFID tags (explained in more detail below) that corresponds to and encodes the card identity of the paying card 102 or 104 in a unique manner such that the card identity is readable only by a compatible RFID reader device (explained below).

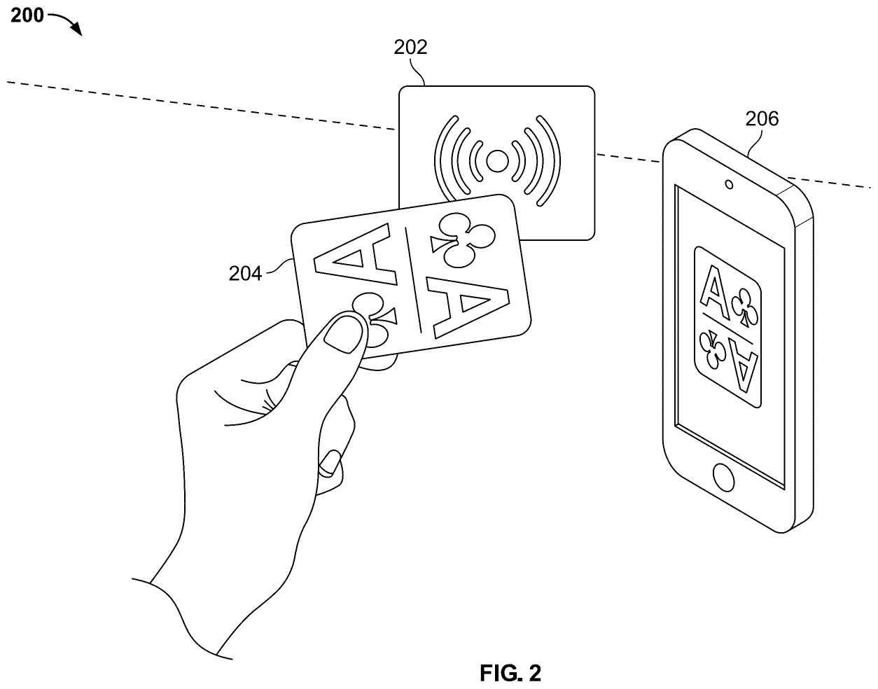

FIG. 2 is an illustrative view of a card identity recognition system 200 that may include a proximity based sensor such as a RFID reader device 202, in accordance with an example embodiment of this disclosure. Referring to FIG. 2, The card identity recognition system 200 may be typically configured to recognize and identify the card identity of an example physical playing card 204 (similar to 102 and 104 of FIG. 1). The card identity recognition system 200 may be further configured to convert the card identity of the physical playing card 204 into a digital representation of the physical playing card 204. The digital representation of the physical playing card 204 may be a visual representation or an audio representation or an audio-visual representation of the physical playing card 204. In operation, the proximity based sensor such as the RFID reader device 202 may detect, recognize and identify the card identity of the physical playing card 204. In an example embodiment, the RFID reader device 202 may detect, recognize and identify the card identity of the physical playing card 204, based on several artificial intelligence (AI) and machine learning (ML) algorithms for RFID signal recognition, used to train the system for detecting, recognizing and identifying the card identities of physical playing cards 204.

In an example embodiment, playing cards 204 of FIG. 2 may be coupled with or embedded with any one of the several types of proximity based sensors or tags or circuits such as capacitive, doppler effect, inductive, magnetic, optical, photoelectric, photocell, laser rangefinder, thermal, radar, sonar, ultrasonic, fiber optic, hall effect sensors or tags or circuits and the card identity recognition system 200 may include corresponding proximity based sensor or tag or circuit reader devices 202 that can recognize and identify the card identities of the physical playing cards.

Various implementations of the present disclosure may be operationalized using contemporary, emerging and future hardware and software systems, subsystems and components as are (and/or likely and/or will be) available with the Internet technology product businesses such as Google Inc. (referred to as “Google”). In an example embodiment, the card identity recognition system 200 may be an Android phone embedded with a RFID reader device or a mat or table spread embedded with a RFID reader devices.

In an example embodiment, the artificial intelligence algorithm may implement Google's “Tensorflow” AI or the like to instantaneously recognize the physical cards, based on pre-trained models (more technical details and specification available at https://www.tensorflow.org are incorporated herewith). As is commonly known in the artificial intelligence (AI) and machine learning art, TensorFlow is an end-to-end open source platform for machine learning. Further, TensorFlow may be used for managing several aspects of a machine learning system. Implementations of the present disclosure may be operationalized using suitable and compatible TensorFlow APIs to develop and train machine learning models.

Further, the pre-trained models may be generated using several other Google tools. As a non-limiting example, various implementations of the present disclosure may use the “Teachable Machine” aspect of tensorflow.js to train an entire deck of physical playing cards for the purpose of identity recognition. Teachable Machine typically uses TensorFlow.js, a library (more technical details and specification available at https://teachablemachine.withgoogle.com/train/image are incorporated herewith) for machine learning in Javascript, to train and run RFID signal recognition models for use in a web browser.

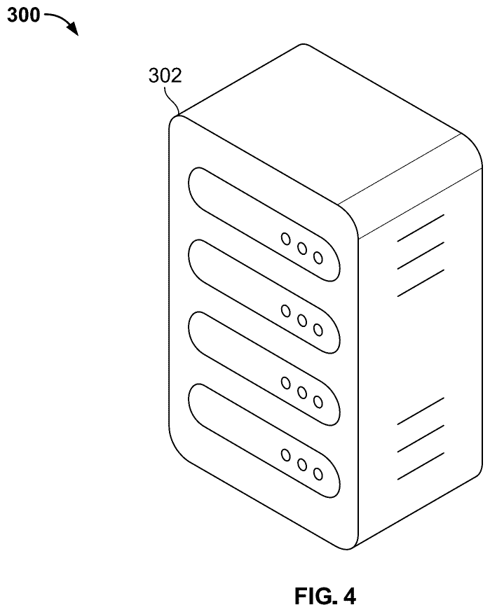

Once detected, the card identity of a specific physical card 204 may be registered on a card identity registration device 206 and then instantaneously sent to a web server (described in more details in relation to FIG. 4 below) in real time and then broadcasted, securely, to a human card player. The human card player may view the same physical card 204 in real time, represented digitally in virtual reality or augmented reality as a virtual visual representation of the physical card 204. Further, the human card player may interact with the virtual visual representation of the physical card 204 by touching or grabbing the virtual visual representation of the physical card 204 naturally with his or her hands that are tracked and represented virtually.

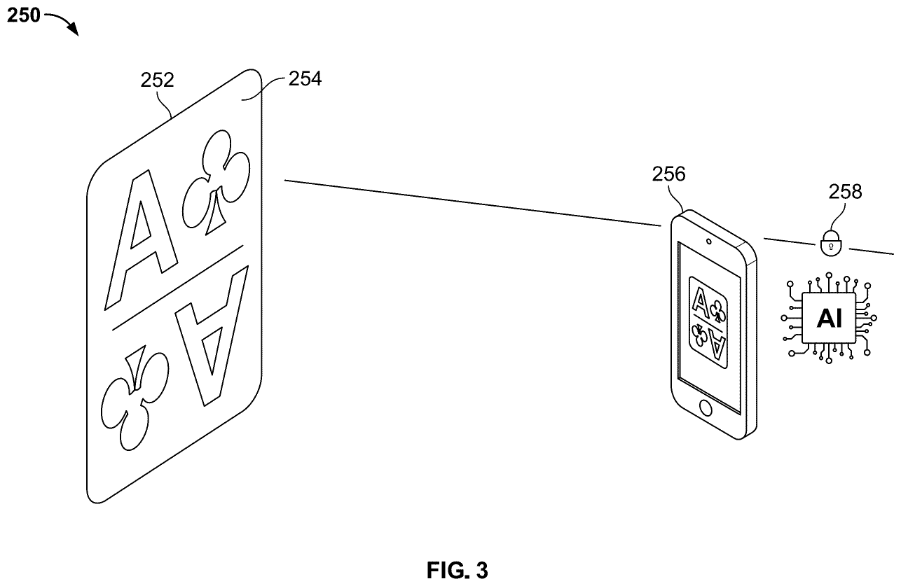

FIG. 3 is an illustrative view of a card identity recognition system 250, in accordance with an example embodiment of this disclosure. Referring to FIG. 3, the card identity recognition system 250 may be an image recognition system that may include an example playing card 252 with an image-bearing face 254, a camera 256 positioned as a card-face image recognition system, which may be available as a part of a mobile device, and a card identity registration device 258, in accordance with an example embodiment of this disclosure. The image recognition system 250 may be configured to recognize the image-bearing face 254 of the physical playing card 252. The image recognition system 250 may be further configured to convert the image-bearing face 254 of the physical playing card 252 into a digital representation of the physical playing card 252. In operation, the image recognition system (or the camera) 256 may detect the playing card 252, based on several artificial intelligence (AI) and machine learning (ML) algorithms for image recognition, used to train the system, specifically, for playing cards.

Various implementations of the present disclosure may be operationalized using Internet technology product businesses such as Google Inc. (referred to as “Google”). In an example embodiment, the image recognition system 250 may be an Android phone camera. In an example embodiment, the artificial intelligence algorithm may implement Google's “Tensorflow” or similar other AI models to instantaneously recognize the physical cards, based on pre-trained models.

As a non-limiting example, various implementations of the present disclosure may use pre-trained models generated using several other tools available on the Internet. Once detected, the image-bearing face 254 of the specific physical card 252 may be instantaneously sent to a web server (described in more details in relation to FIG. 4 below) in real time and then broadcasted, securely, to a human card player. The human card player may view the same physical card 252, in real time, represented digitally in virtual reality or augmented reality as a virtual visual representation of the physical card. Further, the human card player may interact with the virtual visual representation of the physical card 252 by grabbing or touching the virtual visual representation of the physical card 252 naturally with his or her hands that are tracked and represented virtually.

FIG. 4 is an illustrative view 300 of a web server 302, in accordance with an example embodiment of this disclosure. Referring to FIG. 4, the web server may be electronically connected with the card identity recognition system 200 of FIG. 2 and card identity recognition system 250 of FIG. 3. The web server 302 may be further configured to host the digital representation of the physical playing card 204 of FIG. 2 or 252 of FIG. 3 uploaded by the card identity recognition system 200 (FIG. 2) or 250 (FIG. 3).

Various implementations of the present disclosure may be operationalized using web servers such as Google's “Firebase”, Amazon Web Services (AWS), Microsoft Azure App Service, Google Cloud Platform (GCP) App Engine, Heroku, Netlify or the like as real-time servers that broadcast virtual reality or augmented reality images securely back out to a remote viewer. Firebase, as is commonly known in the web server and database art, is a set of back-end cloud computing service and application development platform provided by Google. Firebase may be used for real-time data transfer. (More technical details and specification available at https://firebase.google.com/docs/database are incorporated herewith). Example embodiments of the present disclosure may use the “Realtime Database” feature, specifically, in Firebase to allow for instant data transfer.

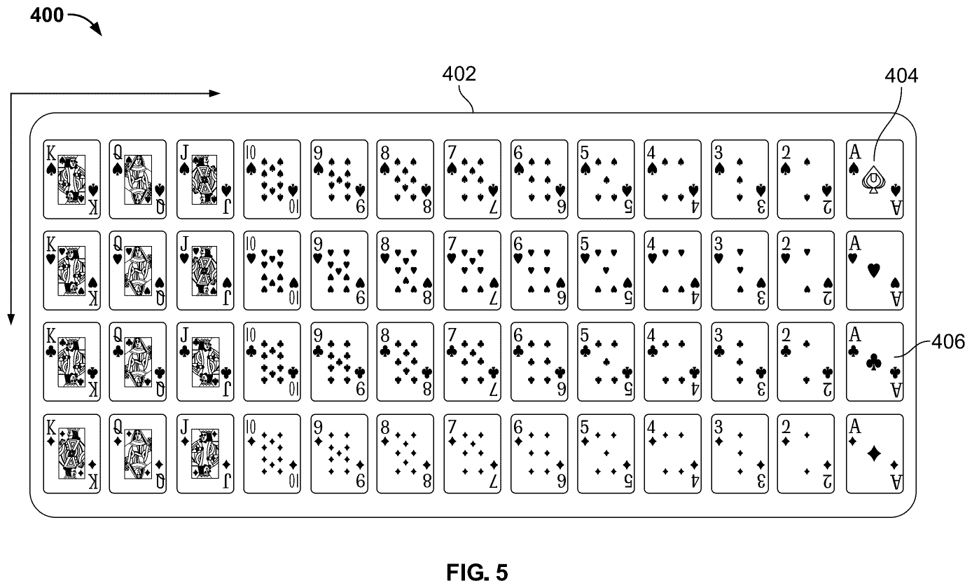

FIG. 5 is an illustrative view 400 of a digital identity interpreter 402 for playing cards, in accordance with an example embodiment of this disclosure. Referring to FIG. 5, the system of the present disclosure includes digital representation 404 of an example first playing card 102 (FIG. 1) or 104 (FIG. 1) or 204 (FIG. 2) or 252 (FIG. 3), digital representation 406 of an example second playing card 102 (FIG. 1) or 104 (FIG. 1) or 204 (FIG. 2) or 252 (FIG. 3) and likewise, digital representation of all of the card identities of the physical playing cards 102 (FIG. 1) or 104 (FIG. 1) or 204 (FIG. 2) or 252 (FIG. 3) in a two-dimensional bitmap that is integrated into a larger scene (also referred to as “sprite” graphic), a technique commonly used in video games to help streamline and optimize graphical assets.

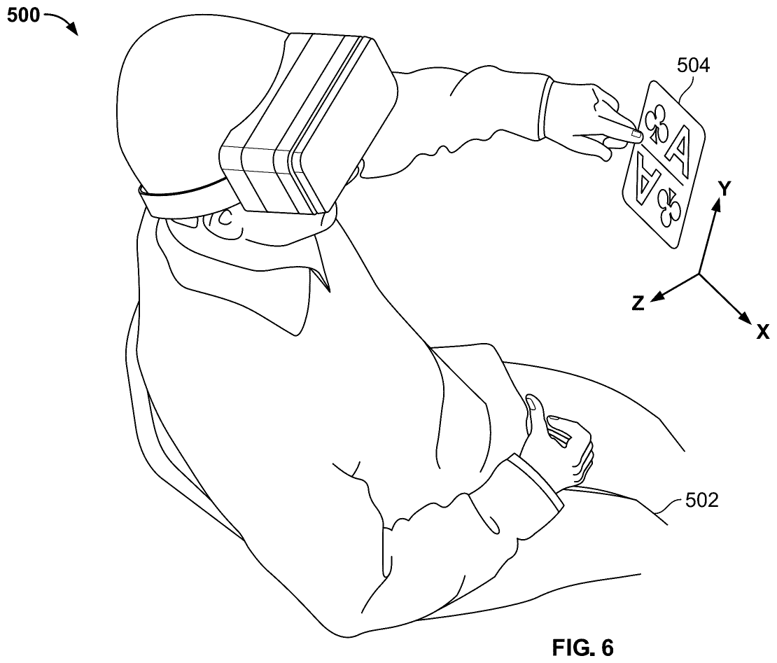

FIG. 6 is an illustrative view 500 of a virtual visual representation of the card identities of the physical playing cards 102 (FIG. 1) or 104 (FIG. 1) or 204 (FIG. 2) or 252 (FIG. 3) as viewed by a human player 502, on a virtual reality or augmented reality viewing device 504, in accordance with an example embodiment of this disclosure. FIG. 6 is also an illustrative view of a virtual visual representation 502 of the image-bearing face 254 (FIG. 2) of the physical playing card 102 (FIG. 1) or 104 (FIG. 1) or 204 (FIG. 2) or 252 (FIG. 3) as viewed by a human player 502 on a virtual reality or augmented reality viewing device 504, in accordance with an example embodiment of this disclosure.

Referring to FIG. 6, a system of the present disclosure includes a virtual reality viewing device 504 electronically connected with the web server 302 (FIG. 3) and configured to communicate with the web server 302 (FIG. 3). The virtual reality viewing device 504 may be further configured to receive the digital representation of the physical playing cards 102 (FIG. 1) or 104 (FIG. 1) or 204 (FIG. 2) or 252 (FIG. 3) broadcasted by the web server 302 (FIG. 3). The virtual reality viewing device 504 may be also configured to decrypt the digital representation of the physical playing cards 102 (FIG. 1) or 104 (FIG. 1) or 204 (FIG. 2) or 252 (FIG. 3) into a virtual visual representation of the image-bearing face 254 (FIG. 2) of the physical playing cards 102 (FIG. 1) or 104 (FIG. 1) or 204 (FIG. 2) or 252 (FIG. 3). The virtual reality viewing device 504 may be further configured to display the virtual visual representation of the image-bearing faces 254 (FIG. 2) of the physical playing cards 102 (FIG. 1) or 104 (FIG. 1) or 204 (FIG. 2) or 252 (FIG. 3) to a human card player 502 accessing the virtual reality viewing device 504 and playing with the virtual visual representation of the image-bearing face 254 (FIG. 2) of the physical playing cards 102 (FIG. 1) or 104 (FIG. 1) or 202 (FIG. 2) or 252 (FIG. 3).

Various implementations of the gaming system of the present disclosure may be operationalized using any standard virtual reality or augmented reality enabled web browser that accesses and connects with the web server (Firebase, as a non-limiting example) using the aforementioned broadcasting mechanism. A-Frame, as a non-limiting example, or the like may be used for virtual reality digital card rendering or interaction with the digital cards. (More technical details and specification available at https://aframe.io are incorporated herewith). As is commonly known in the virtual reality or augmented reality art, A-Frame is an open-source web framework typically used for building virtual reality (VR) experiences and this framework is developed and maintained by developers from “Supermedium” and Google.

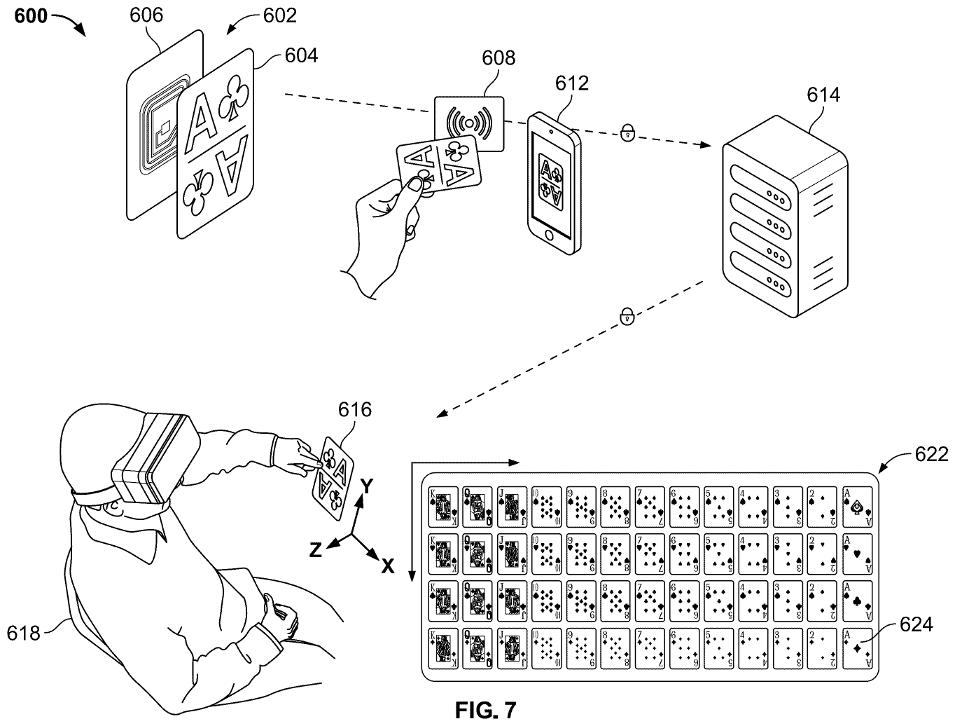

FIG. 7 is an illustrative method 600 of playing a virtual game with playing cards, in accordance with an example embodiment of this disclosure. Referring to FIG. 7, the method begins with receiving a pack or deck or any number of physical playing cards 602. The physical playing cards 602, typically, may have their corresponding card identities such as “5” of “Spades”, “4” of “Diamonds”, “King” of “Clubs”, “Ace” of “Hearts” and the like imaged on example front face 604. The back face 606 of physical playing cards 602 may be coupled with proximity sensor circuitry. During a game of the playing cards, a person, commonly known as a “dealer”, may position a physical playing card 602 near or in contact or in the proximity of a card identity recognition system 608 (proximity sensor for reading card identity of a physical playing card) and thereby present the card identity of the physical playing card 602 to the card identity registration device 612, without seeing the card identity himself or herself.

The card identity registration device 612 may recognize the card identity of the physical playing card 602 and convert the card identity of the physical playing card 602 into a digital representation of the physical playing card 602. In an example embodiment, the card identity registration device 612 may be trained with appropriate artificial intelligence and machine learning algorithms to recognize the card identities of the physical playing cards 602 and convert the card identities of the physical playing cards 602 into digital representations of the physical playing cards 602. Further, the card identity registration device 612 may upload the digital representations of the physical playing cards 602 on to a web server 614. The web server 614 may be typically configured to broadcast the digital representation of the physical playing card 602 to a virtual reality viewing device 616.

The virtual reality viewing device 616 may decrypt the digital representation of the physical playing card 602 into a virtual visual representation of the card identity of the original physical playing card 602 dealt (also referred to as “dispensed” or “distributed”) by the dealer. The virtual reality viewing device 616 may further display the virtual visual representation of the card identity of the physical playing card 602 to a human card player 618 accessing the virtual reality viewing device 616. The human card player 618 may play with the virtual visual representation of the card identity of the physical playing card 602, in virtual reality, using a digital identity interpreter 622 that includes a collection of digital representations 624 of example playing cards 602. In operation, multiple human card players 618, potentially located in different geographical locations, are enabled to play simultaneously, with a live card game dealer, in real-time, so that it feels natural.

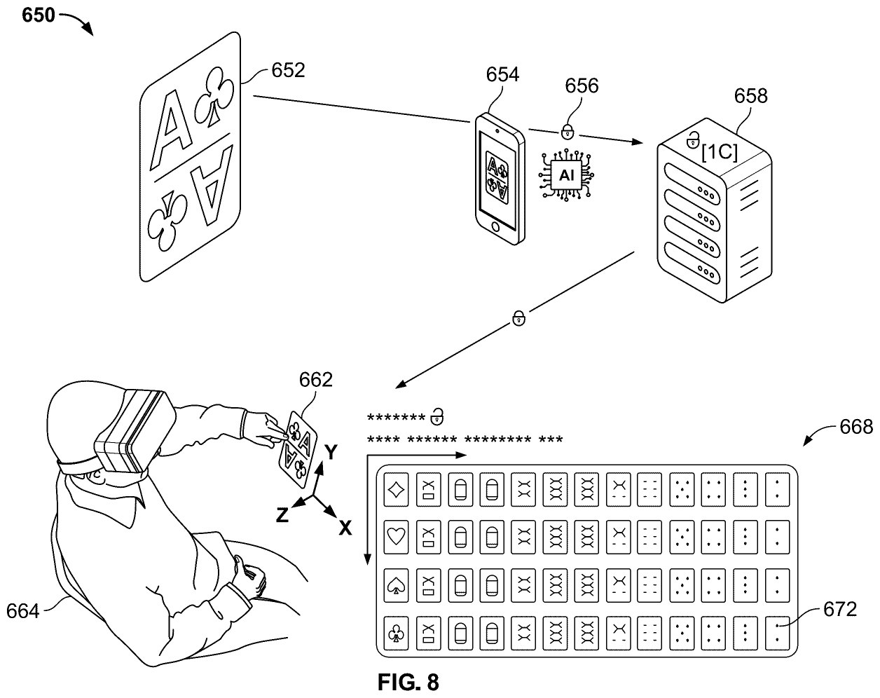

FIG. 8 is an illustrative method 650 of playing a virtual game with playing cards 652, in accordance with an example embodiment of this disclosure. Referring to FIG. 8, the method begins with receiving a pack or deck or any number of physical playing cards 652. The physical playing cards 652, typically, have their corresponding image-bearing faces 254 (FIG. 2). During a game of the playing cards, a person, commonly known as a “dealer”, may display an image-bearing face 254 (FIG. 2) of a physical playing card 652 to an image recognition system 654, without seeing the image-bearing face 254 (FIG. 2) himself or herself.

The image recognition system 654, trained with appropriate artificial intelligence and machine learning algorithms, for example, may recognize the image-bearing face 254 (FIG. 2) of the physical playing card 652, register the image-bearing face 254 (FIG. 2) of the physical playing card 652 on a card identity registration device 656 and convert the image-bearing face 254 (FIG. 2) of the physical playing card 652 into a digital representation of the physical playing card 652. Further, the card identity registration device 656 may upload the digital representation of the physical playing card 652 on a web server 658. The web server 658 may be typically configured to broadcast the digital representation of the physical playing card 652 to a virtual reality viewing device 662.

The virtual reality viewing device 662 may decrypt the digital representation of the physical playing card 652 into a virtual visual representation of the image-bearing face 254 (FIG. 2) of the original physical playing card 652 dealt (also referred to as “dispensed” or “distributed”) by the dealer. The virtual reality viewing device 662 may further display the virtual visual representation of the image-bearing face 254 (FIG. 2) of the physical playing card 652 to a human card player 664 accessing the virtual reality viewing device 662. The human card player 664 may play with the virtual visual representation of the image-bearing face 254 (FIG. 2) of the physical playing card 652 in virtual reality using digital identity interpreter 668 that includes a collection of digital representation 672 of example playing cards 652. In operation, multiple human card players 664, potentially located in different geographical locations, are enabled to play simultaneously, with a live card game dealer, in real-time, so that it feels natural.

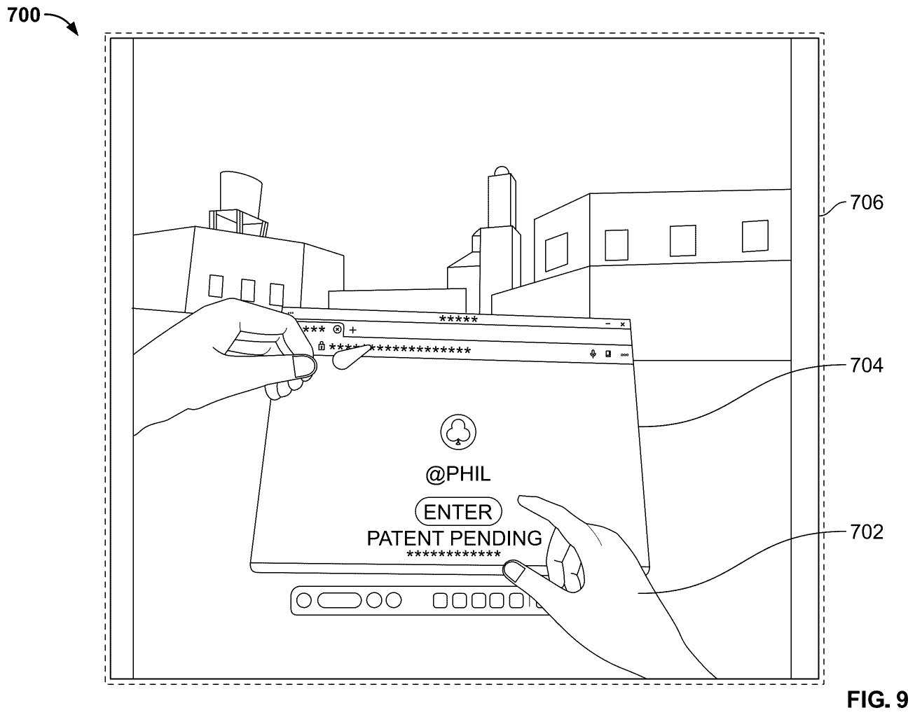

FIG. 9 is an illustrative virtual reality view 700 of a human card player 702 playing with virtual visual representation of the card identity of the physical playing card 102 (FIG. 1) or 104 (FIG. 1) or 204 (FIG. 2) or 252 (FIG. 3), as viewed on a virtual image of playing console 704 of a virtual reality or augmented reality viewing device 706, in accordance with an example embodiment of this disclosure.

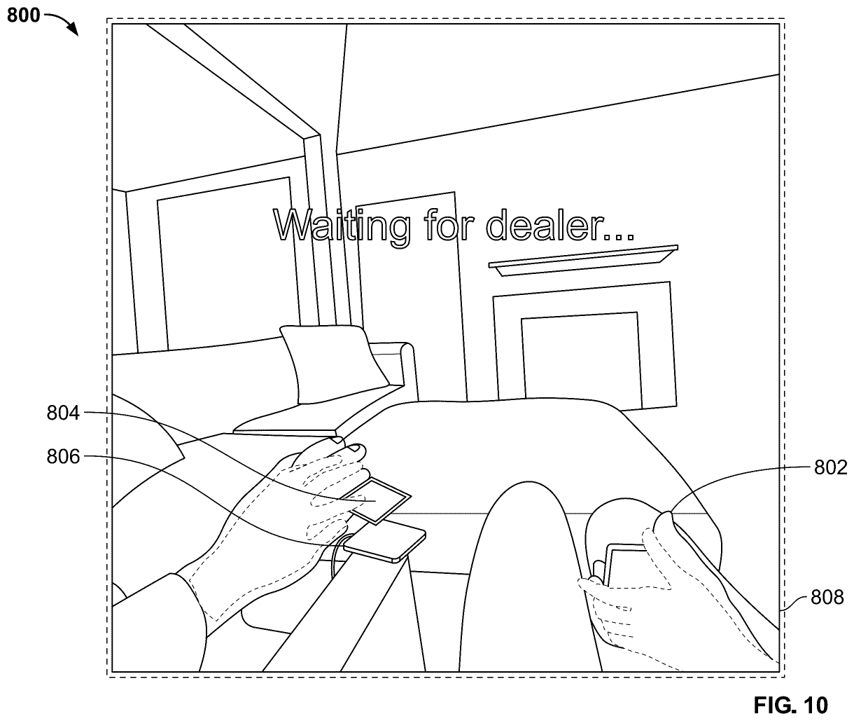

FIG. 10 is an illustrative virtual reality image 800 of a human card player 802 playing with virtual visual representation of the card identities of the physical playing cards 804 or 102 (FIG. 1) or 104 (FIG. 1) or 204 (FIG. 2) or 252 (FIG. 3) positioned on a card reading device 806 for a single card, as viewed on a virtual reality or augmented reality viewing device 808, in accordance with an example embodiment of this disclosure.

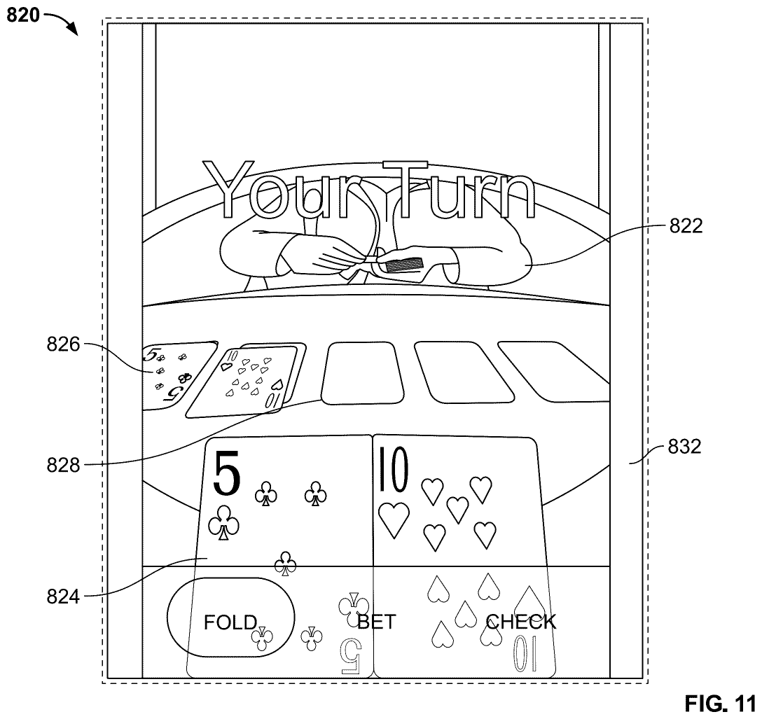

FIG. 11 is an illustrative virtual reality image 820 of a human card player 822 playing with virtual visual representation 824 of the card identities of the physical playing cards 826 or 102 (FIG. 1) or 104 (FIG. 1) or 204 (FIG. 2) or 252 (FIG. 3) positioned on a card reading device 828 for multiple cards, as viewed on a virtual reality or augmented reality viewing device 832, in accordance with an example embodiment of this disclosure.

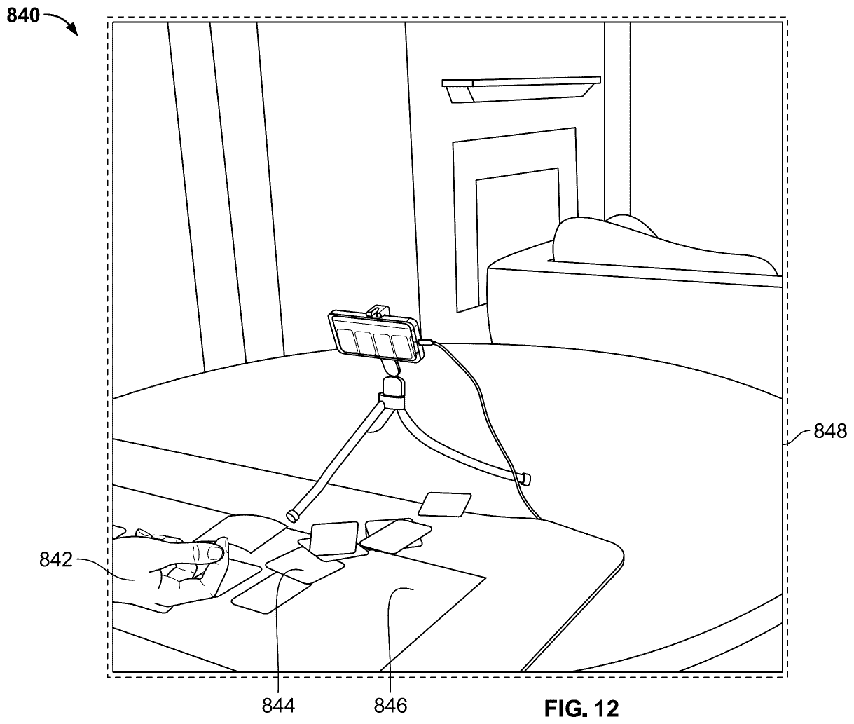

FIG. 12 is an illustrative virtual reality image 840 of a human card player 842 playing with virtual visual representation of the card identities of the physical playing cards 844 or 102 (FIG. 1) or 104 (FIG. 1) or 204 (FIG. 2) or 252 (FIG. 3) positioned on a card reading mat or device 846 for multiple cards, as viewed on a virtual reality or augmented reality viewing device 848, in accordance with an example embodiment of this disclosure.

Referring to FIGS. 10 to 12, the virtual reality game may begin with physical playing cards 804 (FIG. 10) or 824 (FIG. 11) or 844 (FIG. 12) or 102 (FIG. 1) or 104 (FIG. 1) or 204 (FIG. 2) or 252 (FIG. 3) with their corresponding card identities and a dealer may position a physical playing card 804 (FIG. 10) or 824 (FIG. 11) or 844 (FIG. 12) or 102 (FIG. 1) or 104 (FIG. 1) or 204 (FIG. 2) or 252 (FIG. 3) near or in the proximity of a card identity recognition system 200 (FIG. 2) or 250 (FIG. 3) and thereby presenting the card identity of the playing card 804 (FIG. 10) or 824 (FIG. 11) or 844 (FIG. 12) or 102 (FIG. 1) or 104 (FIG. 1) or 204 (FIG. 2) or 252 (FIG. 3) to the card identity recognition system 200 (FIG. 2) or 250 (FIG. 3), without seeing the card identity himself or herself.

The card identity recognition system 200 (FIG. 2) or 250 (FIG. 3) may recognize the card identity of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) and convert the card identity of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) into a digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3). The card identity recognition system may upload the digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) on a web server that broadcasts the digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) to a virtual reality viewing device. The virtual reality viewing device may decrypt the digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) into a virtual visual representation of the card identity of the original physical playing card 804 (FIG. 10) or 824 (FIG. 11) or 844 (FIG. 12) or 102 (FIG. 1) or 104 (FIG. 1) or 204 (FIG. 2) or 252 (FIG. 3) dealt and display the virtual visual representation of the card identity of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) to one or more human card players 502 (FIG. 6) or 618 (FIG. 7) or 664 (FIG. 8) or 704 (FIG. 9) or 802 (FIG. 10) or 822 (FIG. 11) or 842 (FIG. 12) accessing and playing with the virtual reality viewing device 504 (FIG. 6) or 616 (FIG. 7) or 662 (FIG. 8) or 706 (FIG. 9) or 808 (FIG. 10) or 832 (FIG. 11) or 848 (FIG. 12).

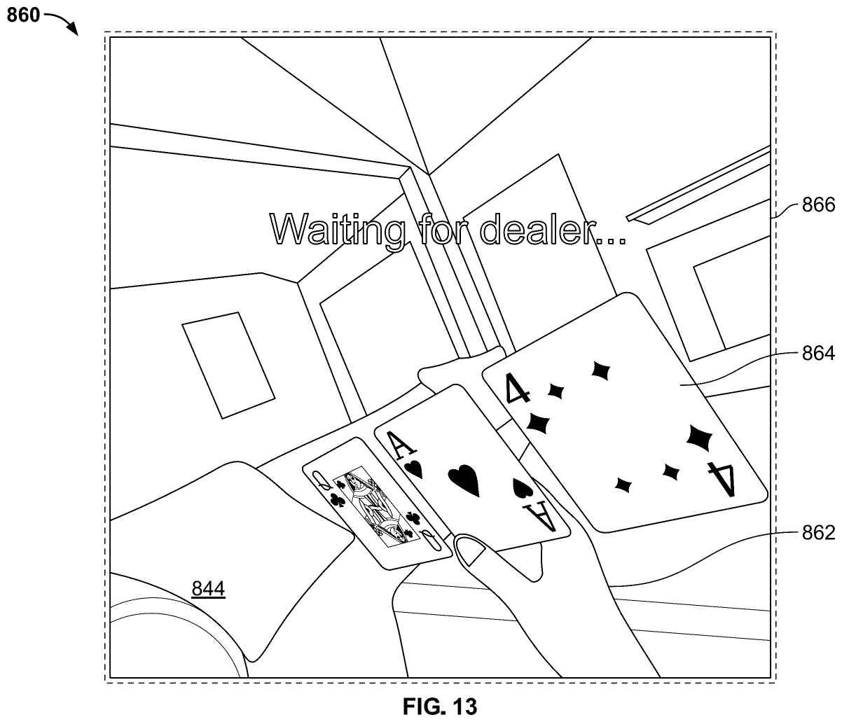

FIGS. 13 to 15 are illustrative virtual reality images of a human card player playing with virtual visual representations of the image-bearing faces (254 of FIG. 2) of the physical playing cards, as viewed on a virtual reality or augmented reality viewing device, in accordance with an example embodiment of this disclosure.

FIG. 13 is an illustrative virtual reality image 860 of a human card player (virtual image) 862 playing with virtual visual representation 864 of the card identities of the physical playing cards 804 (FIG. 10) or 824 (FIG. 11) or 844 (FIG. 12) or 102 (FIG. 1) or 104 (FIG. 1) or 204 (FIG. 2) or 252 (FIG. 3), as viewed on a virtual reality or augmented reality viewing device 866, in accordance with an example embodiment of this disclosure.

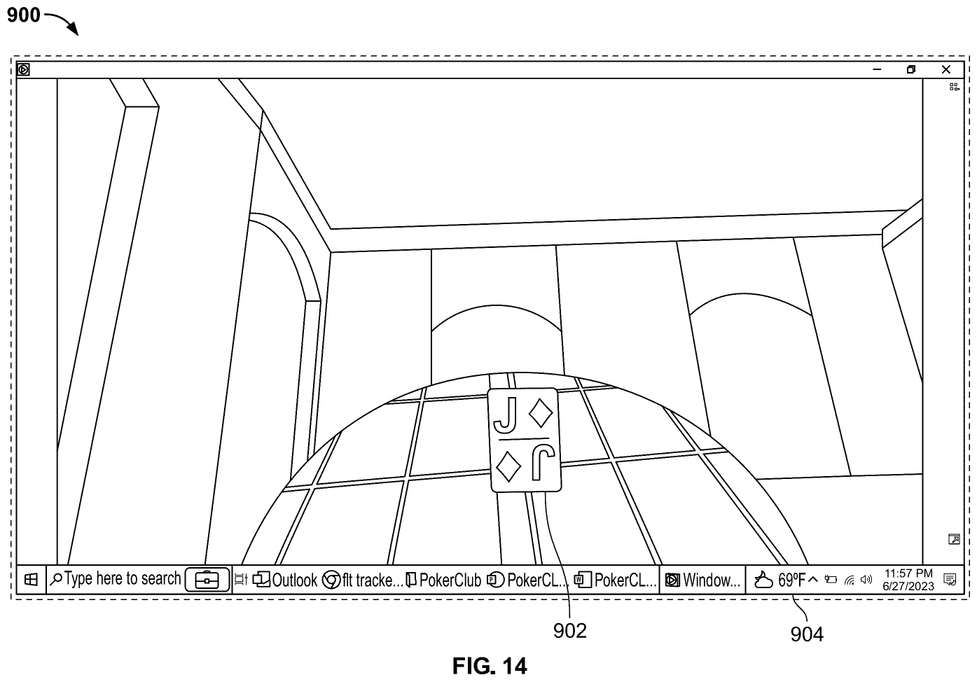

FIG. 14 is an illustrative virtual reality image 900 of a human card player playing with virtual visual representation 902 of the card identities of the physical playing cards 804 (FIG. 10) or 824 (FIG. 11) or 844 (FIG. 12) or 102 (FIG. 1) or 104 (FIG. 1) or 204 (FIG. 2) or 252 (FIG. 3), as viewed on a virtual reality or augmented reality viewing device 904, in accordance with an example embodiment of this disclosure.

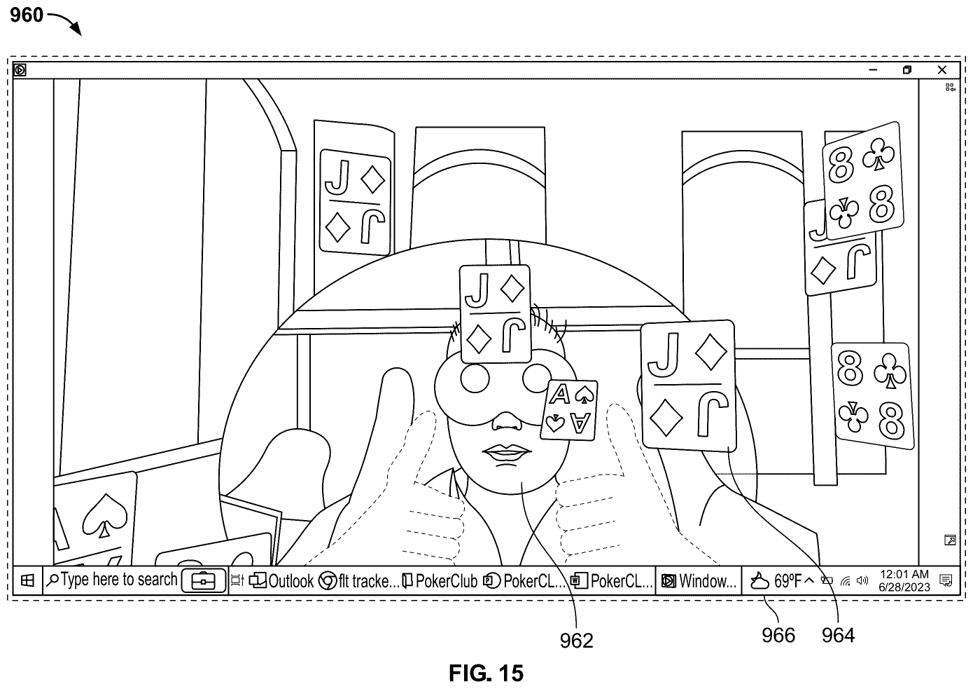

FIG. 15 is an illustrative virtual reality image 960 of a human card player 962 playing with virtual visual representation 964 of the card identities of the physical playing cards 804 (FIG. 10) or 824 (FIG. 11) or 844 (FIG. 12) or 102 (FIG. 1) or 104 (FIG. 1) or 204 (FIG. 2) or 252 (FIG. 3), as viewed on a virtual reality or augmented reality viewing device 966, in accordance with an example embodiment of this disclosure.

Referring to FIGS. 13 to 15, the virtual reality game may begin with physical playing cards 804 (FIG. 10) or 824 (FIG. 11) or 844 (FIG. 12) or 102 (FIG. 1) or 104 (FIG. 1) or 204 (FIG. 2) or 252 (FIG. 3) with their corresponding image-bearing faces and a dealer may display an image-bearing face 254 (FIG. 3) of a physical playing card 804 (FIG. 10) or 824 (FIG. 11) or 844 (FIG. 12) or 102 (FIG. 1) or 104 (FIG. 1) or 204 (FIG. 2) or 252 (FIG. 3) to an image recognition system 250 (FIG. 3), without seeing the image-bearing face himself or herself.

The image recognition system 250 (FIG. 3) may recognize the image-bearing face of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) and convert the image-bearing face 254 (FIG. 3) of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) into a digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3). The image recognition system 250 (FIG. 3) may upload the digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) on a web server 302 (FIG. 4) that broadcasts the digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) to a virtual reality viewing device 504 (FIG. 6) or 616 (FIG. 7) or 662 (FIG. 8) or 866 (FIG. 13) or 904 (FIG. 14) or 966 (FIG. 15). The virtual reality viewing device 504 (FIG. 6) or 616 (FIG. 7) or 662 (FIG. 8) or 866 (FIG. 13) or 904 (FIG. 14) or 966 (FIG. 15) may decrypt the digital representation of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) into a virtual visual representation of the image-bearing face 254 (FIG. 3) of the original physical playing card 804 (FIG. 10) or 824 (FIG. 11) or 844 (FIG. 12) or 102 (FIG. 1) or 104 (FIG. 1) or 204 (FIG. 2) or 252 (FIG. 3) dealt and display the virtual visual representation of the image-bearing face of the physical playing card 804 (FIG. 10) or 824 (FIG. 11) or 844 (FIG. 12) or 102 (FIG. 1) or 104 (FIG. 1) or 204 (FIG. 2) or 252 (FIG. 3) to one or more human card players 502 (FIG. 6) or 618 (FIG. 7) or 664 (FIG. 8) or 704 (FIG. 9) or 802 (FIG. 10) or 822 (FIG. 11) or 864 (FIG. 13) or 964 (FIG. 15) accessing and playing with the virtual reality viewing device 504 (FIG. 6) or 616 (FIG. 7) or 662 (FIG. 8) or 866 (FIG. 13) or 904 (FIG. 14) or 966 (FIG. 15).

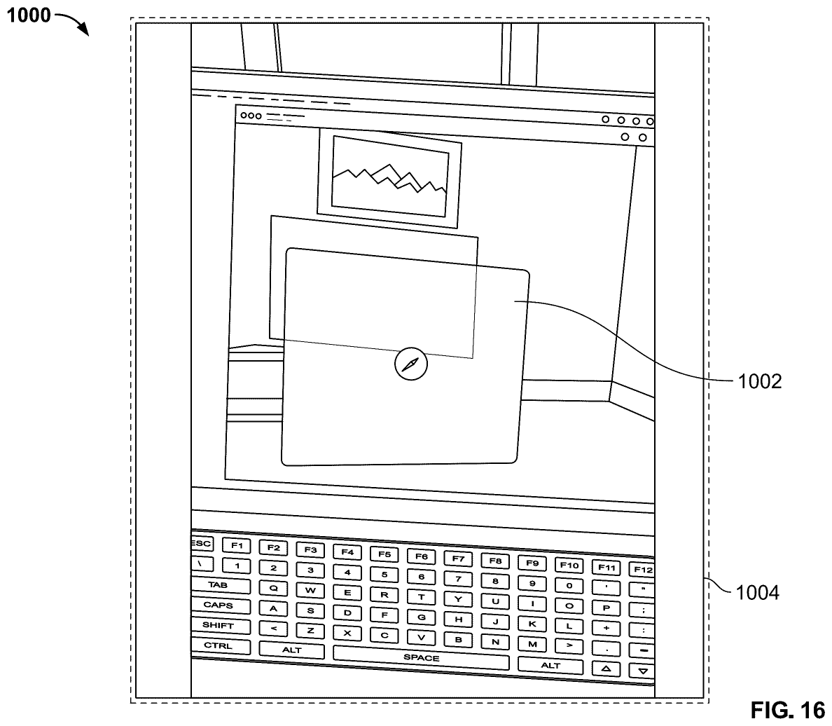

FIG. 16 is a non-limiting, representative and illustrative view 1000 of virtual image of playing console 1002 hosted on an example “visionOS” virtual reality operating system 1004 (also referred to as “computing system”) of Apple Inc., that may be operationalized in various implementations of the disclosed subject matter. As is commonly known the virtual reality and augmented reality art, visionOS may include the “safari” web browser integrated within. Other similar vision operating systems may be used. For example, similar virtual reality operating system from Meta Inc. or the like may be used along with corresponding web browsers integrated within. Any virtual reality or augmented reality viewing device 504 (FIG. 6) or 616 (FIG. 7) or 662 (FIG. 8) or 706 (FIG. 9) or 808 (FIG. 10) or 832 (FIG. 11) or 848 (FIG. 12) or 866 (FIG. 13) or 904 (FIG. 14) or 966 (FIG. 15) or 1004 (FIG. 16) that supports hand tracking may be used with various implementations of the disclosed the system and method.

In operation, the systems, subsystems and the components of the present disclosure are independent of each other and may be configured to collaborate with each other based on their mutual compatibility and technical compatibility with the respective hardware and software platforms. As a non-limiting example, the player card functionality may be operationalized on any contemporary and/or emerging and/or future real time web server or virtual reality or augmented reality viewing device and/or the card dealer functionality may be operationalized on any contemporary and/or emerging and/or future Android device to deal the cards in real time, if the respective systems are mutually compatible and compatible with their respective hardware and software platforms.

In an example embodiment, the web server 302 (FIG. 4) may be a real time server operationalized to capture the video and audio (with live “chroma” key, also known as “greenscreen”) transmissions from the card dealer. This functionality may typically allow multiple players to play simultaneously, and view and communicate with each other. The players, however, may not be able to view the card identities of their respective physical cards.

One or more parts of the above implementations may include software. Software is a general term whose meaning can range from part of the code and/or metadata of a single computer program to the entirety of multiple programs. A computer program (also referred to as a program) includes code and optionally data. Code (sometimes referred to as computer program code or program code) includes software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (typically, though not necessarily an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices. The term “consumer” refers to another computer service that is running the reusable software components of the system of FIG. 1.

Referring to FIG. 16, the computing system 1002 may include an electronic device according to some example implementations. The electronic device may include hardware including a set of one or more processor(s), one or more network interfaces (wireless and/or wired), and machine-readable media having stored therein software (which includes instructions executable by the set of one or more processor(s)). The machine-readable media may include non-transitory and/or transitory machine-readable media. Each of the previously described clients and server components may be implemented in one or more electronic devices. In one implementation: 1) each of the clients is implemented in a separate one of the electronic devices (e.g., in end user devices where the software represents the software to implement clients to interface directly and/or indirectly with server components (e.g., software may represents a web browser, a native client, a portal, a command-line interface, and/or an application programming interface (API) based upon protocols such as Simple Object Access Protocol (SOAP), Representational State Transfer (REST), etc.)); 2) server components is implemented in a separate set of one or more of the electronic devices (e.g., a set of one or more server devices where the software represents the software to implement the framework for providing additional security to protected fields in protected views); and 3) in operation, the electronic devices implementing the clients and server components would be communicatively coupled (e.g., by a network) and would establish between them (or through one or more other layers and/or other services) connections for submitting requests to server components and returning responses to the clients. Other configurations of electronic devices may be used in other implementations (e.g., an implementation in which the client and server components are implemented on a single one of electronic device).

During operation, an instance of the software (also referred to as a software instance; and in the more specific case of an application, as an application instance) may be executed. In electronic devices that use compute virtualization, the set of one or more processor(s) may typically execute software to instantiate a virtualization layer and one or more software container(s) (e.g., with operating system-level virtualization, the virtualization layer may represent a container engine (such as Docker Engine by Docker, Inc. or rkt in Container Linux by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software is executed within the software container on the virtualization layer. In electronic devices where compute virtualization is not used, the instance on top of a host operating system is executed on the “bare metal” electronic device. The instantiation of the instance, as well as the virtualization layer and software containers if implemented, are collectively referred to as software instance(s).

Alternative implementations of an electronic device may have numerous variations from that described above. For example, customized hardware and/or accelerators might also be used in an electronic device.

Referring to FIG. 16, the system 1002 may be coupled to user devices over a network. The service(s) may be on-demand services that are made available to one or more of the users working for one or more entities other than the entity which owns and/or operates the on-demand services (those users sometimes referred to as outside users) so that those entities need not be concerned with building and/or maintaining a system, but instead may make use of the service(s) when needed (e.g., when needed by the users). The service(s) may communicate with each other and/or with one or more of the user devices via one or more APIs (e.g., a REST API). In some implementations, the user devices are operated by users, and each may be operated as a client device and/or a server device. In some implementations, one or more of the user devices are separate ones of the electronic device or include one or more features of the electronic device.

In some implementations, the system 1002 may be any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system may be is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 1002 may be is a multi-tenant cloud computing architecture supporting multiple services, such as one or more of the following types of services: Customer relationship management (CRM); Configure, price, quote (CPQ); Business process modeling (BPM); Customer support; Marketing; Predictive Product Availability for Grocery Delivery; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“application store”); Data modeling; Security; and Identity and access management (IAM). For example, system 1002 may include an application platform that enables PAAS for creating, managing, and executing one or more applications developed by the provider of the application platform, users accessing the system 1002 via one or more of user devices, or third-party application developers accessing the system 1002 via one or more of user devices.

In some implementations, one or more of the service(s) may use one or more multi-tenant databases, as well as system data storage for system data accessible to system. In certain implementations, the system 1002 may include a set of one or more servers that are running on server electronic devices and that are configured to handle requests for any authorized user associated with any tenant (there is no server affinity for a user and/or tenant to a specific server). The user devices may communicate with the server(s) of system 1002 to request and update tenant-level data and system-level data hosted by system 1002, and in response the system 1002 (e.g., one or more servers in system 1002) automatically may generate one or more Structured Query Language (SQL) statements (e.g., one or more SQL queries) that are designed to access the desired information from the multi-tenant database(s) and/or system data storage.

In some implementations, the service(s) are implemented using virtual applications dynamically created at run time responsive to queries from the user devices and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1002 and the user devices.

Each user device (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1002. For example, the user interface device can be used to access data and applications hosted by system 1002, and to perform searches on stored data, and otherwise allow one or more of users to interact with various GUI pages that may be presented to the one or more of users. User devices might communicate with system 1002 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices might include an HTTP client, commonly referred to as a “browser,” for sending and receiving HTTP messages to and from server(s) of system 1002, thus allowing users of the user devices to access, process and view information, pages and applications available to it from system 1002 over network.

In the above description, numerous specific details such as resource partitioning/sharing/duplication implementations, types and interrelationships of system components, and logic partitioning/integration choices are set forth in order to provide a more thorough understanding. Example embodiments disclosed herein may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A system for playing with physical playing cards in virtual reality, the system comprising:
a plurality of physical playing cards having corresponding card identities;
a card identity recognition system configured to recognize a card identity of a physical playing card,
the card identity recognition system further configured to convert the card identity of the physical playing card into a digital representation of the physical playing card;
a web server electronically connected with the card identity recognition system, the web server configured to host the digital representation of the physical playing card uploaded by the card identity recognition system; and
a virtual reality viewing device electronically connected with the web server and configured to communicate with the web server,
the virtual reality viewing device further configured to receive the digital representation of the physical playing card broadcasted by the web server,
the virtual reality viewing device further configured to decrypt the digital representation of the physical playing card into a virtual visual representation of the card identity of the physical playing card,
the virtual reality viewing device further configured to display the virtual visual representation of the card identity of the physical playing card to a human card player accessing the virtual reality viewing device and playing with the virtual visual representation of the card identity of the physical playing card.

2. The system of claim 1, wherein the card identity recognition system comprises a proximity based card identity recognition system.

3. The system of claim 2, wherein the proximity based card identity recognition system comprises a RFID based card identity recognition system.

4. The system of claim 3, wherein the card identity recognition system is further configured to convert the card identity of the physical playing card into the digital representation of the physical playing card.

5. The system of claim 1, wherein the card identity recognition system comprises an image recognition system configured to recognize an image-bearing face of a physical playing card.

6. The system of claim 5, wherein the image recognition system is further configured to convert the image-bearing face of the physical playing card into the digital representation of the physical playing card.

7. The system of claim 6, wherein the virtual visual representation of the card identity of the physical playing card comprises a virtual visual representation of the image-bearing face of the physical playing card.

8. A method of playing with physical playing cards in virtual reality, the method comprising:
receiving a plurality of physical playing cards having corresponding card identities;
presenting a card identity of a physical playing card to a card identity recognition system;
recognizing the card identity of the physical playing card, by the card identity recognition system;
converting the card identity of the physical playing card into a digital representation of the physical playing card, by the card identity recognition system;
uploading the digital representation of the physical playing card on a web server, by the card identity recognition system;
broadcasting the digital representation of the physical playing card to a virtual reality viewing device, by the web server;
decrypting the digital representation of the physical playing card into a virtual visual representation of the card identity of the physical playing card, by the virtual reality viewing device;
displaying the virtual visual representation of the card identity of the physical playing card to a human card player accessing the virtual reality viewing device; and
playing with the virtual visual representation of the card identity of the physical playing card in virtual reality, by the human card player.

9. The method of claim 8, wherein the card identity recognition system comprises a proximity based card identity recognition system.

10. The method of claim 9, wherein the proximity based card identity recognition system comprises a RFID based card identity recognition system.

11. The method of claim 10, wherein the card identity recognition system is further configured to convert the card identity of the physical playing card into the digital representation of the physical playing card.

12. The method of claim 8, wherein the card identity recognition system comprises an image recognition system configured to recognize an image-bearing face of a physical playing card.

13. The method of claim 12, wherein the image recognition system is further configured to convert the image-bearing face of the physical playing card into the digital representation of the physical playing card.

14. The method of claim 13, wherein the virtual visual representation of the card identity of the physical playing card comprises a virtual visual representation of the image-bearing face of the physical playing card.

15. A non-transitory machine-readable storage medium that provides instructions that, if executed by a processor, are configured to cause the processor to perform operations comprising:
receiving a plurality of physical playing cards having corresponding card identities;
presenting a card identity of a physical playing card to a card identity recognition system;
recognizing the card identity of the physical playing card, by the card identity recognition system;
converting the card identity of the physical playing card into a digital representation of the physical playing card, by the card identity recognition system;
uploading the digital representation of the physical playing card on a web server, by the card identity recognition system;
broadcasting the digital representation of the physical playing card to a virtual reality viewing device, by the web server;
decrypting the digital representation of the physical playing card into a virtual visual representation of the card identity of the physical playing card, by the virtual reality viewing device;
displaying the virtual visual representation of the card identity of the physical playing card to a human card player accessing the virtual reality viewing device; and
playing with the virtual visual representation of the card identity of the physical playing card in virtual reality, by the human card player.

16. The non-transitory machine-readable storage medium of claim 15, wherein the card identity recognition system comprises a proximity based card identity recognition system.

17. The system of claim 16, wherein the proximity based card identity recognition system comprises a RFID based card identity recognition system.

18. The non-transitory machine-readable storage medium of claim 17, wherein the card identity recognition system is further configured to convert the card identity of the physical playing card into the digital representation of the physical playing card.

19. The non-transitory machine-readable storage medium of claim 15, wherein the card identity recognition system comprises an image recognition system configured to recognize an image-bearing face of a physical playing card.

20. The non-transitory machine-readable storage medium of claim 19, wherein the image recognition system is further configured to convert the image-bearing face of the physical playing card into the digital representation of the physical playing card.

21. The non-transitory machine-readable storage medium of claim 20, wherein the virtual visual representation of the card identity of the physical playing card comprises a virtual visual representation of the image-bearing face of the physical playing card.
